(19) United States
(12) Patent Application Publication
(10) Pub. No.: US 2003/0184157 A1
(43) Pub. Date: Oct. 2, 2003

(54) Grouser assembly

(76) Inventors: Thomas McNutt, Libby, MT (US); Darby McNutt, Libby, MT (US)

Correspondence Address: Burkhart & Burkhart, Patent Attorneys, 940 Dakota Avenue, Whitefish, MT, 59937, US

(21) Appl. No.: 10/313,877

(22) Filed: Dec. 5, 2002

Related U.S. Application Data
(60) Provisional application No. 60/367,575, filed on Mar. 26, 2002.

(51) Int. Cl. B62D 55/28

(52) U.S. Cl. 305/180

(57) ABSTRACT

A detachable grouser assembly for use with vehicles having continuous flexible tracks includes a traction grouser adapted and constructed to fit onto a track of the vehicle. A selectively releasable mechanical attachment assembly connects the traction grouser to the track of the vehicle.

### CROSS-REFERENCE TO RELATED APPLICATION

This application is related to Provisional Application No. 60/367,575, filed on Mar. 26, 2002, and entitled “Quick Connect Grouser's “track claws”, the benefit of which is hereby claimed under 35 USC §119.

### FIELD OF THE INVENTION

The present invention relates generally to grousers for tracked vehicles, and specifically to grousers that are selectively deployable.

### BACKGROUND OF THE INVENTION

Ground-engaging endless track chain assemblies have long been employed to provide ground contact for vehicles used in construction, fighting of forest fires, logging, and other demanding off-road pursuits. The track chain assemblies, and particularly the individual track shoes thereof, have experienced considerable research development. The standard track shoe consists of a steel plate with a single grouser or cleat running across its width. While this generally affords good traction, such single grouser track shoes do not provide adequate traction on steep slopes, or ground that is frozen or extremely muddy.

Not surprisingly, a variety of solutions have arisen in attempting to accommodate this problem by changing grouser configuration on the track links themselves. For example, U.S. Pat. No. 4,637,665 to Burdick is directed to a track assembly for a track-type vehicle having a plurality of first and second distinct individual track shoes joined together to form an endless loop. The first shoes have a projecting grouser bar which has a first plurality of teeth and the second shoes have a projecting grouser bar which has a second plurality of teeth. The first and second shoes are arranged in an alternating pattern with the teeth of the first shoes staggered relative to the teeth of the second shoes. Conventional grousered track shoes generally provide track-type vehicles with sufficient surface traction for most work tasks of the vehicle. However, in some special work applications, the conventional grouser track shoes is inadequate to provide the required penetration to achieve sufficient tractive force. For such special work applications, the subject toothed grouser track shoes penetrate the surface and provide the necessary traction to effectively perform the work function.

U.S. Pat. No. 4,805,968 to Connerley deals with a track shoe for use with a track-laying vehicle. The shoe includes a cast body portion having three bored lug segments spaced along the front of the shoe and a pair of bored lug segments spaced along the rear of the shoe. The cast body portion has a fin-like guide member for engagement with sprocket and bogey wheels. Pairs of reinforcing ribs extend lengthwise along the shoe which form the longitudinal sides of sprocket tooth engaging openings. A single grouser extends along the width of the shoe to reinforce the body portion and to provide traction between the shoe and ground as the vehicle moves along a terrain. The grouser member and the rear lugs form the leading sides and the trailing sides of the sprocket tooth openings, respectively.

U.S. Pat. No. 3,964,797 to Swanson shows a track shoe with staggered grousers includes an elongated rectangular planar body portion with a predetermined leading edge, a trailing edge, a pair of side edges and a flat outer wear surface thereon and having a leading grouser extending integrally outwardly from the wear surface in parallel juxtaposed relation to the leading edge centrally thereof, and with a pair of laterally spaced trailing grousers extending integrally outwardly from the wear surface in parallel juxtaposed relation to the trailing edge and laterally inwardly from the side edges, to cause adhering mud or the like to be released from entrapment between the leading grouser, the trailing grousers and the wear surface of the planar body portion for improved penetration and traction.

The above approaches involve replacement of the links in the tracks, requiring at least partial disassembly and reassembly of track. It is also known to weld auxiliary grousers directly onto the track links. The time and effort required to so equip a tracked vehicle is prohibitive. Furthermore, when the grousers are either worn out or no longer desired, they must be removed with a cutting torch or similar implement, resulting in additional equipment downtime.

Both built-in and welded-on grousers entail long installation times, often taking a vehicle out of service for at least a day or more. It can be seen from the foregoing that the need exists for simple, inexpensive grouser assembly that overcomes the difficulties of known systems.

### SUMMARY OF THE INVENTION

A detachable grouser assembly for use with vehicles having continuous flexible tracks includes a traction grouser adapted and constructed to fit onto a track of the vehicle. A selectively releasable mechanical attachment assembly connects the traction grouser to the track of the vehicle.

### DESCRIPTION OF THE DRAWINGS

FIG. 1 is a schematic side elevational view of an embodiment of a grouser assembly in accordance with the principles of the present invention.

FIG. 2 is a schematic rear elevational view of the FIG. 1 grouser assembly.

FIG. 3 is a schematic front elevational view of the FIG. 1 grouser assembly.

FIG. 4 is a schematic front elevational view of another embodiment of a grouser assembly in accordance with the principles of the present invention.

FIG. 5 is a schematic side elevational view of the FIG. 4 grouser assembly.

FIG. 6 is a schematic top plan view of the FIG. 4 grouser assembly.

FIG. 7 is a schematic top plan view of another embodiment of a grouser assembly in accordance with the principles of the present invention.

FIG. 8 is a schematic side elevational view of another embodiment of a grouser assembly in accordance with the principles of the present invention.

FIG. 9 is a schematic top plan view of the FIG. 8 grouser assembly.

### DETAILED DESCRIPTION OF THE INVENTION

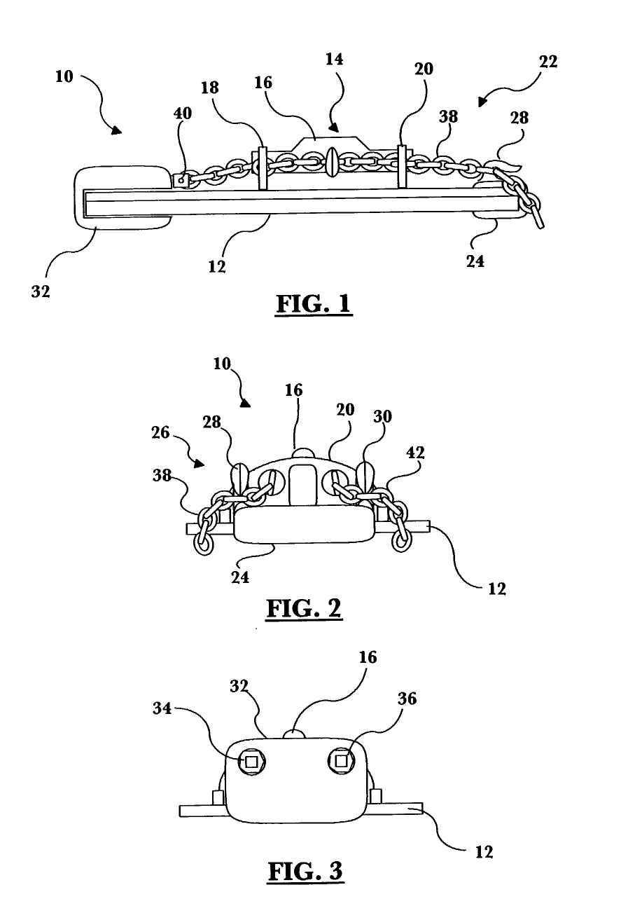

FIGS. 1-3 illustrate a grouser assembly 10 representing one embodiment of the present invention. The grouser assembly 10 is adapted for attachment to a section 12 of a flexible track of tracked vehicle. The grouser assembly 10 includes a traction grouser 14 having a contour that enhances the ability of the track section 12 to grip into surfaces traversed by the tracked vehicle. Here, the traction grouser 14 includes an outwardly-extending cleat 16, and an opposed pair of cleat-supporting chain guides 18, 20.

The traction grouser 14 is secured to the track 12 by a selectively releasable mechanical attachment assembly 22. The attachment assembly 22 includes a first track engaging member 24 on an outside edge of the track section 12. A chain link retainer 26, here illustrated as a pair of hooks 28, 30, is formed on the first track engaging member 24. A second track engaging member 32 is provided to be secured to the inside edge of the track section 12. The second track engaging member 32 is provided with a selectively adjustable chain tensioning mechanism, here shown as a pair of adjustable screw-threaded mechanisms 34, 36. A first chain 38 is attached to a pin 40 on the screw-threaded mechanism 36, through the chain guides 18, 20, and secured to the hook 28. A second chain 42 is attached to a pin 44 on the screw-threaded mechanism 34, through the chain guides 18, 20, and secured to the hook 30. The screw-threaded mechanisms 34, 36 are then tightened to securely affix the traction grouser 14 to the track section 12. When it is desired to remove the traction grouser from the track section, the procedure is reversed, and the traction grouser is non-destructively removed from the track section.

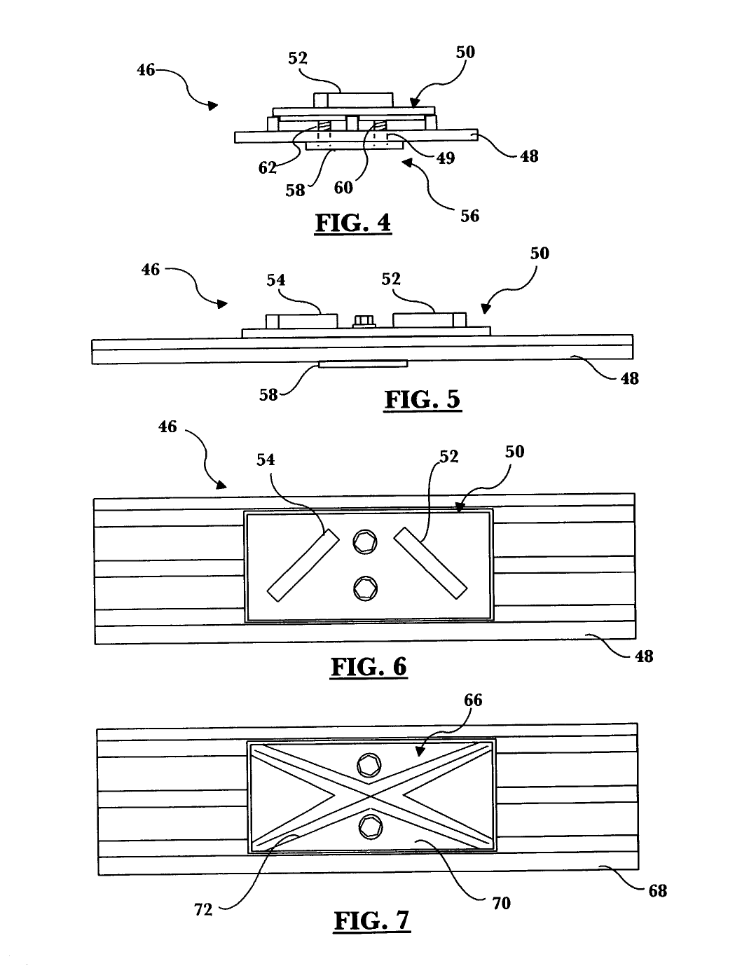

FIGS. 4-6 illustrate a grouser assembly 46 representing another embodiment of the present invention. The grouser assembly 46 is adapted for attachment to a section 48 of a flexible track of tracked vehicle, the sections having a plurality of clean-out holes 49 in standard arrangements. The grouser assembly 46 includes a traction grouser 50 having a contour that enhances the ability of the track section 48 to grip into surfaces traversed by the tracked vehicle. Here, the traction grouser 50 includes outwardly-extending raised traction elements 52, 54 arranged in an open chevron configuration.

The traction grouser 50 is secured to the track section 48 by a selectively releasable mechanical attachment assembly 56. The attachment assembly 56 includes a mounting plate 58 secured on a surface of the track section 48 opposite the surface upon which the traction grouser 50 is mounted. The traction grouser 50 is releasably secured to the mounting plate 58 by a plurality of securing members extending through the clean-out holes 49. In this embodiment, the securing members are provided as a plurality of threaded bolt assemblies 60, 62. In operation, the traction grouser 50 is placed on the track section 48, and the threaded bolt assemblies 60, 62 are placed through the traction grouser 50 and the clean-out holes 49. The threaded bolt assemblies 60, 62 are then secured to the mounting plate 58, via threaded bores in the mounting plate itself, or by threaded nuts (not shown).

FIG. 7 illustrates a grouser assembly 66 representing another embodiment of the present invention. The grouser assembly 66 is adapted for attachment to a section 68 of a flexible track of tracked vehicle, the sections having a plurality of clean-out holes as in the previous embodiment. The grouser assembly 66 includes a traction grouser 70 having a contour that enhances the ability of the track section 68 to grip into surfaces traversed by the tracked vehicle. Here, the traction grouser 70 includes outwardly-extending raised traction elements are configured in a diagonal cross arrangement 72.

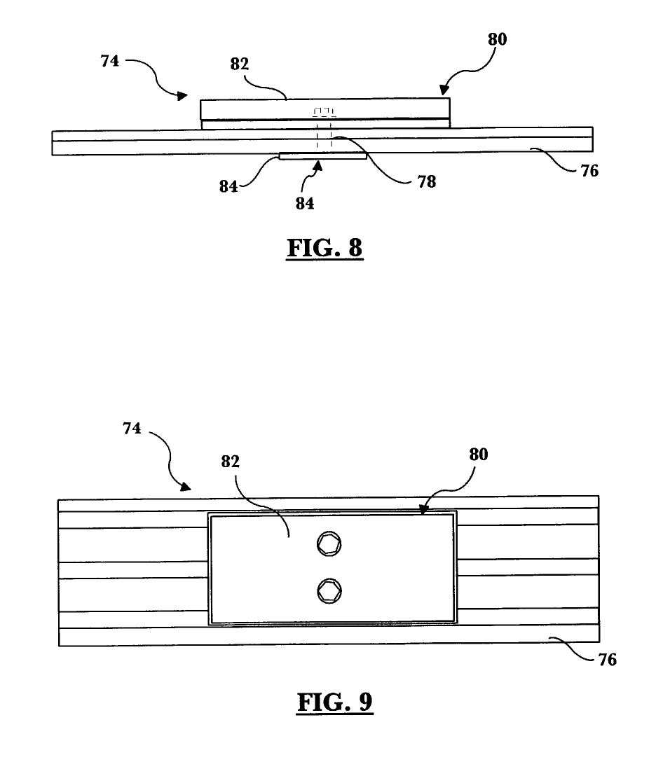

FIGS. 8 and 9 illustrate a grouser assembly 74 representing another embodiment of the present invention. The grouser assembly 74 is adapted for attachment to a section 76 of a flexible track of tracked vehicle, the sections having a plurality of clean-out holes 78 in standard arrangements. The grouser assembly 74 includes a traction grouser 80 having a pad 82 fabricated from a suitable elastomeric material, such as rubber. The pad 82 enhances the ability of the track section 76 to traverse paved surfaces, such as asphalt and concrete, without damage to the surface.

The traction grouser 74 is secured to the track section 76 by a selectively releasable mechanical attachment assembly 84. The attachment assembly 84 includes a mounting plate 86 secured on a surface of the track section 76 opposite the surface upon which the traction grouser 74 is mounted. The traction grouser 74 is releasably secured to the mounting plate 86 by a plurality of securing members extending through the clean-out holes, as described previously.

It is contemplated that sets of 16 grouser assemblies, mounted at evenly spaced intervals on each track of a vehicle, will provide optimal traction enhancement. In such an arrangement, with the grouser assemblies evenly spaced, four traction grousers will be in contact with the surface to be traversed at any given time

Although the present invention has been described with reference to specific embodiments, those of skill in the art will recognize that changes may be made thereto without departing from the scope and spirit of the invention as defined by the appended claims.

What is claimed is:

1. A detachable grouser assembly for use with vehicles having continuous flexible tracks, the grouser assembly comprising the following:
a traction grouser adapted and constructed to fit onto a track of the vehicle; and
a selectively releasable mechanical attachment assembly connecting the traction grouser to the track of the vehicle.

2. A grouser assembly in accordance with claim 1, wherein the selectively releasable mechanical attachment assembly comprises a chain mechanism.

3. A grouser assembly in accordance with claim 2, wherein the chain mechanism comprises the following:
at least one chain retainer on the traction grouser;
a first track engaging member adapted and constructed to engage a first side of the flexible track;
a second track engaging member adapted and constructed to engage a second side of the flexible track;
a first chain connecting the track engaging members to the traction grouser; and
a second chain connecting the track engaging members to the traction grouser.

4. A grouser assembly in accordance with claim 3, further comprising a chain tensioning device associated with the first and second track engaging members.

5. A grouser assembly in accordance with claim 4, wherein the chain tensioning devices comprise the following:
a chain link retainer on the first track engaging member; and
a selectively adjustable chain tensioning mechanism on the second track engaging member.

6. A grouser assembly in accordance with claim 5, wherein the selectively adjustable chain tensioning mechanism on the second track engaging member comprises an adjustable screw threaded mechanism.

7. A grouser assembly in accordance with claim 3, wherein the first track engaging member engages an outside edge of the flexible track, and the second track engaging member engages an inside edge of the flexible track.

8. A grouser assembly in accordance with claim 3, wherein the first track engaging member engages an outside edge of the flexible track, and the second track engaging member engages an inside edge of the flexible track.

9. A grouser assembly in accordance with claim 1, wherein the flexible track includes a plurality of clean-out holes, and the selectively releasable mechanical attachment assembly is secured to the flexible track via the clean-out holes.

10. A grouser assembly in accordance with claim 9, wherein the selectively releasable mechanical attachment assembly comprises the following:
a mounting plate; and
securing members extending through the clean-out holes and releasably connecting the mounting plate to the traction grouser.

11. A grouser assembly in accordance with claim 10, wherein the securing members comprise threaded bolt assemblies.

12. A grouser assembly in accordance with claim 10, wherein the traction member comprises raised traction elements.

13. A grouser assembly in accordance with claim 12, wherein the raised traction elements are configured in a chevron arrangement.

14. A grouser assembly in accordance with claim 12, wherein the raised traction elements are configured in a diagonal cross arrangement.

15. A grouser assembly in accordance with claim 12, wherein the raised traction elements comprise an elastomeric pad.
